(19) United States
(12) Patent Application Publication
(10) Pub. No.: US 2009/0140082 A1
(43) Pub. Date: Jun. 4, 2009

(54) Plasma Spray Nozzle System

(76) Inventor: Lucian Bogdan Delcea, Port Coquitlam (CA)

Correspondence Address: BULL HOUSSER & TUPPER, P O BOX 11130 3000 ROYAL CENTER, 1055 WEST GEORGIA STREET, VANCOUVER, BC, V6E 3R3, CA

(21) Appl. No.: 12/084,770

(22) PCT Filed: Nov. 27, 2006
(86) PCT No.: PCT/CA2006/001939

§ 371 Date: May 9, 2008

Related U.S. Application Data
(60) Provisional application No. 60/742,571, filed on Dec. 6, 2005.

(51) Int. Cl. B05B 1/00

(52) U.S. Cl. 239/589

(57) ABSTRACT

A plasma spray nozzle system for uniform injection of feedstock into a plasma stream. A plasma nozzle is provided, having a bore with an axis, the bore shaped for the passage of a plasma stream. An annular plenum chamber is provided coaxial with and substantially surrounding the bore. A plurality of feedstock injection passages extend from the plenum chamber and converge towards the plasma stream. The plenum chamber is supplied continuously with feedstock material from an outside source. The feedstock is distributed throughout the plenum chamber volume and is exhausted into the plasma stream via the plurality of feedstock injection passages. By selecting an appropriate number of feedstock injection passages a more uniform and symmetrical loading with feedstock of the plasma stream is achieved.

The applicant claims the benefit of U.S. Provisional Application No. 60/742,571 filed Dec. 6, 2005.

### FIELD OF THE INVENTION

This invention relates a plasma nozzle system for injecting feedstock material into a plasma stream with improved uniformity.

### BACKGROUND OF THE INVENTION

Plasma spraying is a method wherein feedstock material is fed into a plasma stream produced usually by a plasmatron. The feedstock is entrapped by the hot plasma stream from which it is transferred heat and momentum. The uniform loading of the plasma stream with feedstock material is essential for the uniform transfer of heat and momentum from the stream to the feedstock material.

Prior art provides for feedstock injection into a plasma stream via one or more injection ports, typically one or two, as shown schematically in FIG. 1 of the drawings. The ports are positioned to inject feedstock either inside the plasma nozzle bore or outside of the plasma nozzle in the proximity of the nozzle bore exit. Each injection port is supplied with feedstock individually. Due to the mixture of lighter and heavier particles in a typical feedstock, the lighter particles tend to bounce off the plasma stream while the heavier particles tend to travel through the plasma stream in a direction opposite to the injection port. This results in an uneven and asymmetrical loading of the plasma stream with feedstock. The heavier loading of the plasma stream in the region of the injection point means that the stream is cooled excessively in that region through heat transfer from the hot gas to the feedstock while the rest of the stream is less utilized. This results in a poor efficiency of the spray process and the uneven heating of the feedstock.

The more injection ports are provided, the more uniform loading of the plasma stream is achieved, provided equal volumes of feedstock can be supplied constantly through each injection port. The main disadvantages of prior art are: a) only a limited number of injection ports is physically possible to be provided; b) each port requires a remote outside source of feedstock; c) supplying the injection ports individually with equal and constant volumes of feedstock is difficult to achieve. These disadvantages translate into the following deleterious effects: a) a reduced number of points of injection result in non-uniform loading of the plasma stream with feedstock material and b) uneven supply with feedstock to one or more of the injection ports results in the asymmetrical loading of the plasma stream.

Examples of prior art are found in U.S. Pat. Nos. 5,744,777 of Bernecki et al.; 5,637,242 of Muehlberger; 6,114,649 of Delcea; 5,573,682 of Beason, Jr. et al.

Uniform loading of the plasma stream is important not only for the uniformity of the resulting plasma sprayed deposit but also for the overall efficiency of the spray process itself. Uneven heating results in a portion of the feedstock material not being heated sufficiently to achieve melting, thus reducing the efficiency of the spray process. Therefore, it would be desirable to provide a feedstock injection method that eliminates or substantially improves the shortcomings of prior art by injecting feedstock more uniformly and better distributed into the plasma stream.

### SUMMARY OF THE INVENTION

It is the object of this invention to provide an improved method of injecting feedstock more uniformly and better distributed into a plasma stream.

The plasma spray nozzle system for injecting feedstock into a plasma stream may include a plasma nozzle having a body and a bore having an axis, the bore extending through the body and shaped to receive, conduct and exhaust a plasma stream. An annular plenum chamber is coaxial with and substantially surrounds the bore, the chamber having a body and at least one supply passage having an outlet end connected to the plenum chamber. A plurality of feedstock injection passages connect the plenum chamber with the bore and extend inwardly from the plenum chamber toward the axis.

The plurality of feedstock injection passages may be uniformly distributed around the axis.

The plurality of feedstock injection passages may be oriented symmetrically with reference to a plane which is perpendicular to the axis and which extends through the outlet end of the supply passage.

The plenum chamber may surround the nozzle body.

The plenum chamber may surround the bore.

The plenum chamber may be integral with the nozzle body.

Thee plurality of feedstock injection passages may be joined to define an annular and continuous passage leading from the plenum chamber to the nozzle bore.

The plenum chamber may partially surround the nozzle body except for a region opposite the outlet end of the supply passage.

The plenum chamber may have a body positioned downstream of the bore outlet, the body having an inner surface coaxial with the nozzle bore. The plurality of feedstock injection passages may lead from the plenum chamber to the inner surface. The inner surface may have a wedge shape oriented inwardly and defining an apex.

A plurality of feedstock injectors may be of a generally tubular form, each injector connected to the outlet of a corresponding feedstock injection passage and extending from the inner surface toward the axis.

The plurality of feedstock injection passages may be joined to define an annular and continuous passage leading from the plenum chamber to the apex.

The supply passage may be angled from a plane aligned with the apex.

The outlet end of the supply passage may be aligned so as not to be aligned with any of the plurality of feedstock injection passages.

The supply passage and the plurality of feedstock injection passages may be aligned in the same plane, the plane perpendicular to the axis.

The plurality of feedstock injection passages may be eight.

A plasma spray nozzle system for injecting feedstock into a plasma stream may include a plasma nozzle having a body and a bore having an axis, the bore extending through the body and shaped to receive, conduct and exhaust a plasma stream. A substantially annular plenum chamber is coaxial with the bore, the chamber having a body and at least one supply passage leading from the outside to the plenum chamber. A substantially annular and continuous feedstock injection slot connects the plenum chamber with the bore and extends inwardly from the plenum chamber toward the axis.

The body may comprise a first and second part separated by a space and wherein the slot is defined by the space.

### BRIEF DESCRIPTION OF THE DRAWINGS

Further features and advantages of the present invention will be evident from the following detailed description of the preferred embodiments and in conjunction with the accompanying drawings in which:

FIG. 1 is a schematic presentation of prior art principles.

FIG. 2 is an isometric schematic of a first preferred embodiment of the present invention shown in cross-section, wherein a plurality of feedstock injection channels extend from the plenum chamber to the nozzle bore.

FIG. 2A is a frontal view of a cross section along line A-A in FIG. 2

FIG. 3 is an isometric schematic of an alternative of the first preferred embodiment of the present invention shown in cross-section, wherein an annular feedstock injection passage extends radially and continuously from the plenum chamber to the nozzle bore.

FIG. 4 is an isometric schematic of a second preferred embodiment of the present invention shown in cross-section, wherein the plenum chamber is positioned proximate to the exit of the plasma nozzle and a plurality of feedstock injectors extend radially from the plenum chamber towards the axis of the nozzle bore.

FIG. 5 is an isometric schematic of an alternative of the second preferred embodiment of the present invention shown in cross-section, wherein the plenum chamber body has a wedge shape with an apex and a plurality of feedstock injection passages lead from the plenum chamber to the apex.

FIG. 6 is an isometric schematic of another alternative of the second preferred embodiment of the present invention shown in cross-section, wherein the plenum chamber body has a wedge shape with an apex and the plurality of feedstock injection passages define an annular passage extending radially and continuously from the plenum chamber to the apex.

### DETAILED DESCRIPTION OF PREFERRED EMBODIMENTS

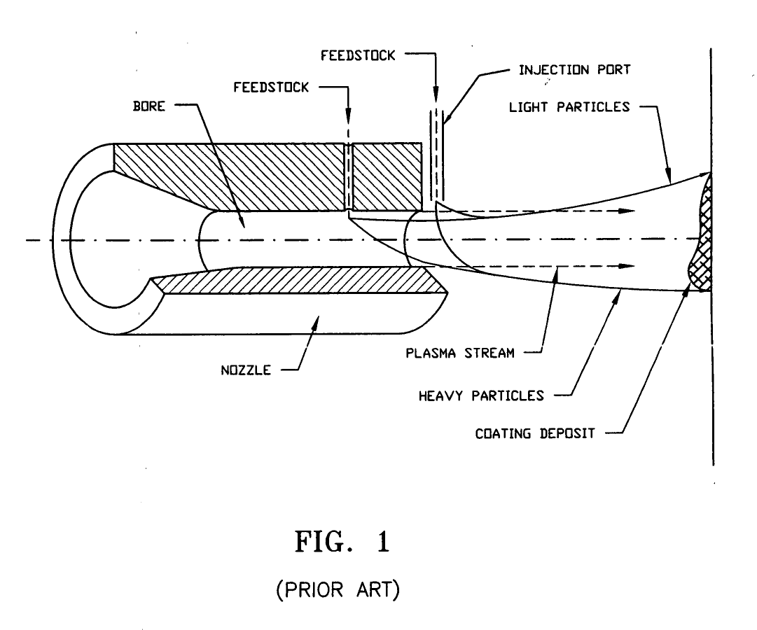

Referring to FIG. 1 of the drawings a prior art nozzle is shown displaying the principles of both internal and external injection of feedstock, generally referred to as “radial injection”. When feedstock material such as a powder material is injected into the plasma stream radially as shown, an in-flight segregation of the lighter and heavier particles occurs leading to a non-uniform deposit on the work piece. Even if two symmetrically opposed powder ports were provided in FIG. 1, it would still result in segregated loading with feedstock of the plasma stream in the region between the powder ports. Moreover, prior art radial injection results in heavy and non-uniform loading of the plasma stream with feedstock particularly when a higher volume of feedstock is being fed. Such prior art radial injection is shown in U.S. Pat. No. 5,637,242 of Muehlberger et al. where two opposing injection passages are provided to inject feedstock inside the plasma nozzle bore. Conversely, U.S. Pat. No. 5,744,777 of Bernecki shows two opposed feedstock injectors positioned externally, proximate to the plasma nozzle exit. U.S. Pat. No. 5,573,682 of Beason, Jr. et al. shows a cluster of feedstock injection passages positioned on one side of the plasma nozzle bore. Such an approach would induce an even more asymmetrical loading with feedstock of the plasma stream. Any other variations of the prior art principles as described above such as the orientation or the distribution of the powder ports would not lead to any fundamental improvements.

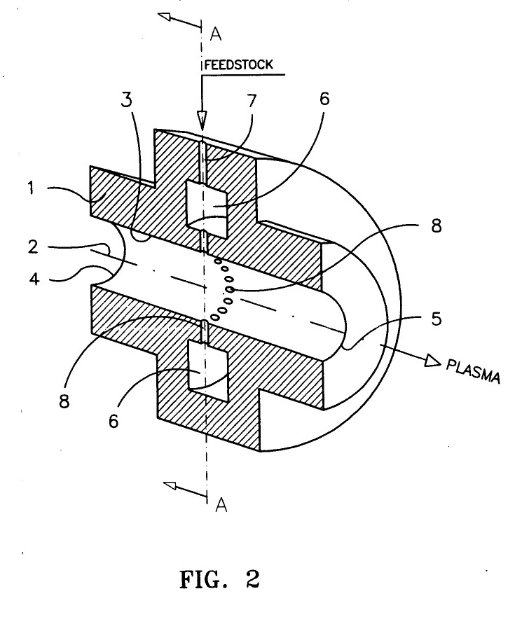

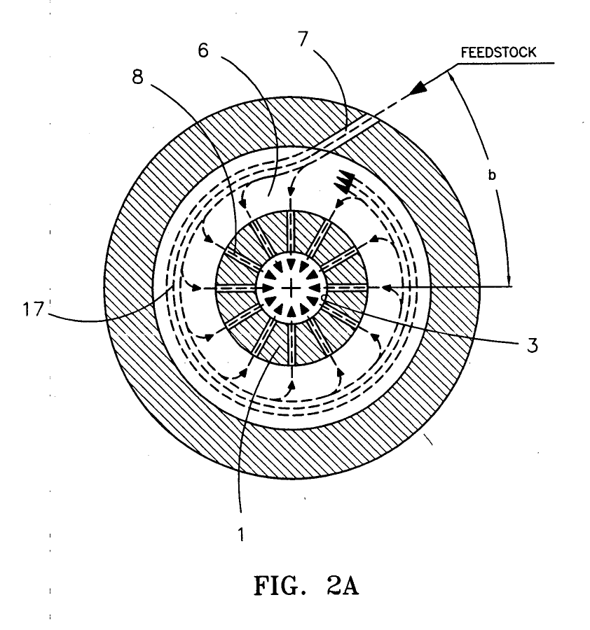

Referring to FIG. 2 of the drawings, a plasma nozzle of a first preferred embodiment of the present invention is shown having a body 1 and an axis 2. A nozzle bore 3 extends coaxially through body 1, the bore 3 having an inlet 4 and an outlet 5. Inlet 4 may be shaped in any appropriate form to efficiently receive a plasma stream while outlet 5 may be shaped in any appropriate form to exhaust the plasma stream and direct it towards a work piece. Similarly, bore 3 maybe shaped in any appropriate form in order to achieve the desired plasma stream dynamic properties such as velocity, laminarity and convergence.

In the first preferred embodiment of the present invention, a plenum chamber 6 is provided, coaxial with bore 3. Chamber 6 is shown having a toroidal like shape wrapped about bore 3. At least one feedstock supply passage 7 leads from outside into the plenum chamber. A plurality of feedstock injection channels 8 extend radially from the plenum chamber to bore 3. Channels 8 are uniformly distributed around the circumference of bore 3 and are positioned symmetrically with reference to a plane perpendicular to the axis and extending through the outer end of the supply passage 7. Preferably, passage 7 penetrates the plenum chamber 6 at an angle such that the feedstock is fed into the chamber tangentially to attain a cyclonic movement and consequently a more uniform distribution of feedstock within chamber 6, as further described in the next paragraph.

Referring to FIG. 2A a frontal view of a cross section along line A-A in FIG. 2 is shown and numerical references correspond to designated numerical references contained in FIG. 2 described above, except as may be modified in this paragraph. Feedstock material is supplied continuously to plenum chamber 6 via a carrier gas passing through feedstock supply passage 7. Passage 7 is oriented at an angle “b” of less than 45 degrees causing the feedstock to enter the plenum chamber tangentially and attain a cyclonic flow 17 inside chamber 7, thus resulting in a more uniform distribution of feedstock within chamber 7 volume. A plurality of feedstock injection channels 8 are shown, uniformly distributed around the nozzle axis, each channel leading from chamber 7, passing through nozzle body 1 and discharging into bore 3. Feedstock powder is extracted from the cyclonic flow 17 through the plurality of channels 8 and is injected more uniformly distributed into the nozzle bore 3. If desired, two symmetrically opposed supply passages 7 may be provided for a more uniform supply of feedstock into the plenum chamber 6.

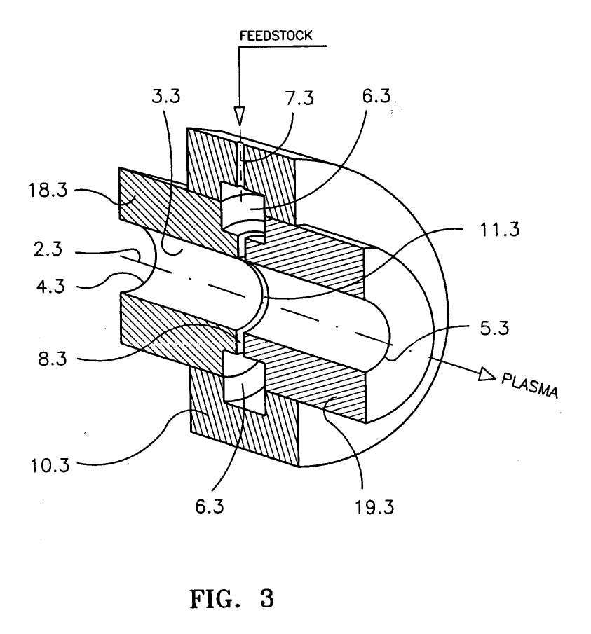

Referring to FIG. 3 of the drawings, an alternative of the first preferred embodiment is shown and numerical references include added designation “0.3”, and it should be understood that those references correspond to designated numerical references contained in FIG. 2 as described above, except as may be modified in this paragraph. The plurality of feedstock injection channels are joined to define an annular and continuous passage 8.3, extending radially from plenum chamber 6.3 to nozzle bore 3.3. One practical way of achieving this embodiment is shown, the plasma nozzle body being now comprised of an upstream body segment 18.4 and a downstream body segment 19.3 separated the annular and continuous passage 8.3. The plenum chamber body 10.3 bridges across and around the two nozzle body segments. Although mechanically more complicated, this design is particularly useful when large volumes of feedstock must be fed into the nozzle bore 3.4. By providing an annular passage 8.3, larger volumes of feedstock can be injected with improved uniformity into a plasma stream passing through bore 3.3.

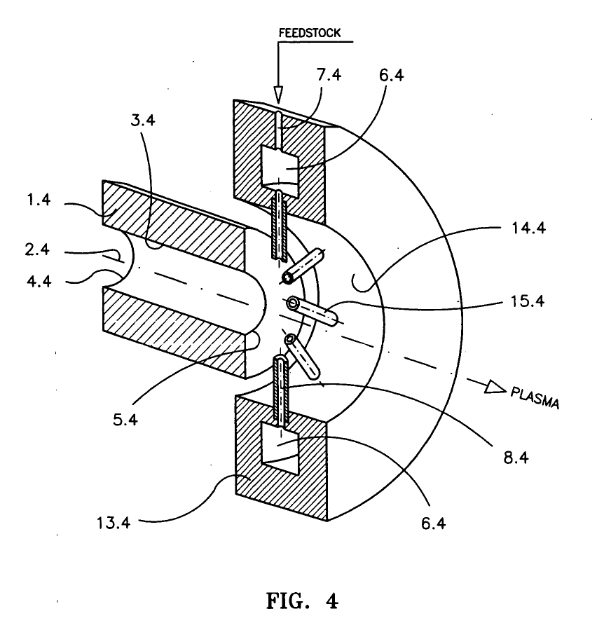

Referring to FIG. 4 of the drawings, a second preferred embodiment of the present invention is shown and numerical references include added designation “0.4”, and it should be understood that those references correspond to designated numerical references contained in FIG. 2 or FIG. 3 as described above, except as may be modified in this paragraph. The plenum chamber 6.4 is shown having a body 13.4 coaxial with nozzle body 1.4 and having an annular inner surface 14.4 coaxial with nozzle bore 3.4. Chamber 6.4 is positioned downstream of and proximate to outlet 5.4 of bore 3.4. A plurality of feedstock injectors 15.4 extend radially from surface 14.5 toward axis 2.4. Feedstock injection passages 8.4 extend from the plenum chamber 6.4 and pass through each feedstock injector 15.4. Preferably, the downstream ends of injectors 15.4 are distributed uniformly around the plasma stream exhausted form bore 3.4.

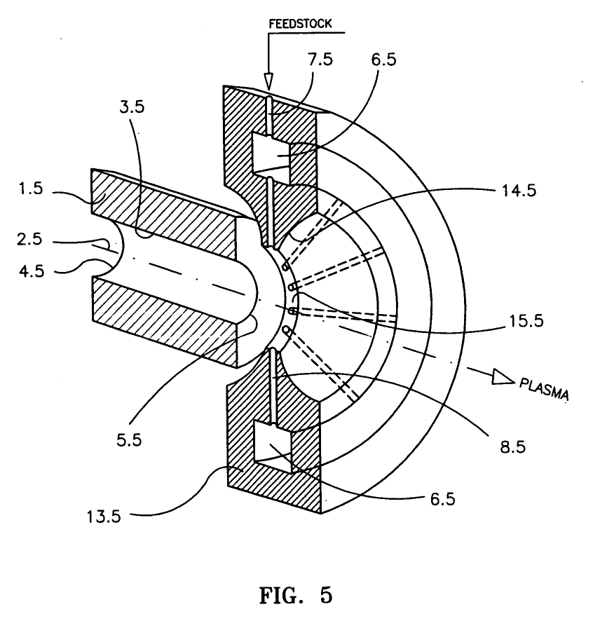

Referring to FIG. 5 of the drawings, an alternative of the second preferred embodiment is shown and numerical references include added designation “0.5”, and it should be understood that those references correspond to designated numerical references contained in FIG. 4 as described above, except as may be modified in this paragraph. The plenum chamber 6.5 is shown having a body 13.5. Body 13.5 has an inner surface 14.5 coaxial with bore 3.5. Preferably, surface 14.5 has a wedge like shape oriented inwardly and defining an apex 15.5 coaxial with bore 3.5. A plurality of feedstock injection passages 8.5 extend radially, leading from the plenum chamber 6.5 to the annular apex 15.5.

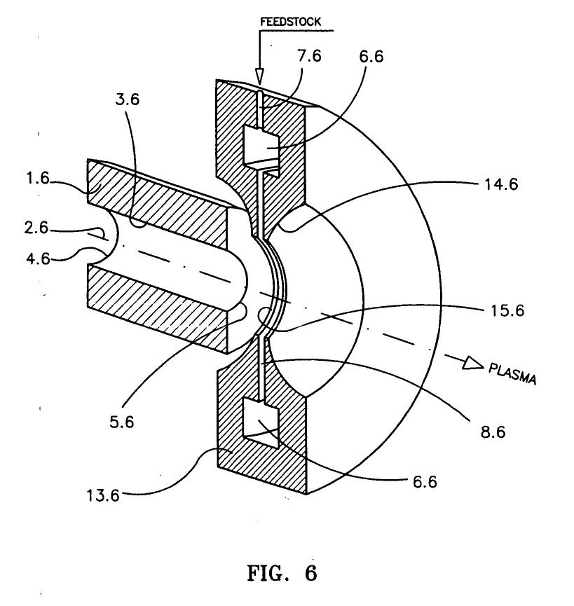

Referring to FIG. 6 of the drawings, another alternative of the second preferred embodiment is shown and numerical references include added designation “0.6”, and it should be understood that those references correspond to designated numerical references contained in FIG. 5 as described above, except as may be modified in this paragraph. The plurality of feedstock injection passages are joined to define an annular feedstock injection passage 8.6 extending radially and continuously through plenum chamber body 13.6 to form a slot, the passage leading from the plenum chamber 6.6 to apex 15.6. By providing an annular passage 8.6, larger volumes of feedstock can be injected with improved uniformity into a plasma stream exhausted from the outlet 5.6 of bore 3.6.

The functioning of the plasma spray system nozzle of the present invention comprises the steps of: supplying and distributing feedstock into the volume of the plenum chamber and exhausting the feedstock from the plenum chamber via the plurality of feedstock injection passages into a plasma stream that passes through the nozzle bore.

A plasma spray gun uses a cathode and an anode to strike an arc discharge within a continuous flow of plasma gas and thus heat the gas to the desired temperature. In some plasma guns, in order to reduce or eliminate the interaction between the anode arc root attachment and the feedstock injection, the nozzle is positioned downstream of the actual anode and therefore the arc does not attach to the bore of the nozzle. An example of such plasma gun is shown in U.S. Pat. No. 6,114,649 of Delcea, the contents of which are incorporated herein by reference. However in many other commercial plasma guns the nozzle is also acting as anode wherein the arc root attaches to the bore of the plasma nozzle, upstream of where the feedstock is injected into the plasma stream. Although shown herein as an independent part, if desired, the plasma spray nozzle bore of the present invention is also suitable for acting as the anode of a plasma gun application, wherein the electric arc attaches to the bore at a location upstream of where the feedstock is injected. The plasma spray nozzle system of the present invention can be successfully applied to other plasma spray gun configurations not described herein as well as to plasma guns intended for uses other than plasma spraying, such as powder processing, plasma synthesis or other desired applications. The plasma spray nozzle system of the present invention can also be applied to devices that employ flammable mixtures as a source of heated gas.

Having described the embodiments of the invention, modifications will be evident to those skilled in the art without departing from the scope and spirit of the invention as defined in the following claims. For example, the plenum may not completely surround the bore, including in a region opposite the outlet end of the supply passage. The plenum may also be integral with the nozzle body. The plenum could surround the body or it could surround the bore without surrounding the body. The outlet end of the supply passage could be oriented so as not to align with a feedstock injection passage. The feedstock injection passages may be oriented at an angle with a plane perpendicular to the axis which extends through the inlet ends of the feedstock passages, to inject feedstock in a generally forward or a backward direction to the direction of travel of the plasma stream. The feedstock injection passages may be oriented to inject feedstock tangentially to the plasma stream. Accordingly, the invention is not limited except as by the appended claims.

I claim:

1. A plasma spray nozzle system for injecting feedstock into a plasma stream comprising:
(a) a plasma nozzle having a body and a bore having an axis, the bore extending through the body and shaped to receive, conduct and exhaust a plasma stream;
(b) an annular plenum chamber coaxial with and substantially surrounding the bore, the chamber having a body and at least one supply passage having an outlet end connected to the plenum chamber; and
(c) a plurality of feedstock injection passages connecting the plenum chamber with the bore, the passages extending inwardly from the plenum chamber toward the axis.

2. The plasma spray nozzle system as defined in claim 1 wherein the plurality of feedstock injection passages are uniformly distributed around the axis.

3. The plasma spray nozzle system as defined in claim 2 wherein the plurality of feedstock injection passages are oriented symmetrically with reference to a plane which is perpendicular to the axis and which extends through the outlet end of the supply passage.

4. The plasma spray nozzle system as defined in claim 1 wherein the plenum chamber surrounds the nozzle body.

5. The plasma spray nozzle system as defined in claim 1 wherein the plenum chamber surrounds the bore.

6. The plasma spray nozzle system as defined in claim 5 wherein the plenum chamber is integral with the nozzle body.

7. The plasma spray nozzle system as defined in claim 4 wherein the plurality of feedstock injection passages are joined to define an annular and continuous passage leading from the plenum chamber to the nozzle bore.

8. The plasma spray nozzle system as defined in claim 2 wherein the plenum chamber partially surrounds the nozzle body except for a region opposite the outlet end of the supply passage.

9. The plasma spray nozzle system as defined in claim 1 wherein the plenum chamber has a body positioned downstream of the bore outlet, the body having an inner surface coaxial with the nozzle bore.

10. The plasma spray nozzle system as defined in claim 9 wherein the plurality of feedstock injection passages lead from the plenum chamber to the inner surface.

11. The plasma spray nozzle system as defined in claim 10 wherein the inner surface has a wedge shape oriented inwardly and defining an apex.

12. The plasma spray nozzle system as defined in claim 10 further comprising a plurality of feedstock injectors of a generally tubular form, each injector connected to the outlet of a corresponding feedstock injection passage and extending from the inner surface toward the axis.

13. The plasma spray nozzle system as defined in claim 11 wherein the plurality of feedstock injection passages are joined to define an annular and continuous passage leading from the plenum chamber to the apex.

14. The plasma spray nozzle system as defined in claim 13 wherein the plenum chamber body comprises a first and second part separated by a space and wherein the continuous passage is a slot defined by the space.

15. The plasma spray nozzle system as defined in claim 1 wherein the axis of the supply passage is angled from the perpendicular with respect to a plane generally defined by the inner surface of the plenum chamber immediately adjacent the outlet end of the supply passage.

16. The plasma spray nozzle system as defined in claim 15 wherein the angle between the axis of the supply passage and a plane generally defined by the inner surface of the plenum chamber immediately adjacent the outlet end of the supply passage, is less than 45 degrees.

17. The plasma spray nozzle system as defined in claim 1 wherein the outlet end of the supply passage is not aligned with any of the plurality of feedstock injection passages.

18. The plasma spray nozzle system as defined in claim 1 wherein the supply passage and the plurality of feedstock injection passages are aligned in the same plane, the plane perpendicular to the axis.

19. The plasma spray nozzle system as defined in claim I wherein the plurality of feedstock injection passages is eight.

20. A plasma spray nozzle system for injecting feedstock into a plasma stream comprising:
(a) a plasma nozzle having a body and a bore having an axis, the bore extending through the body and shaped to receive, conduct and exhaust a plasma stream;
(b) a substantially annular plenum chamber coaxial with the bore, the chamber having a body and at least one supply passage leading from the outside to the plenum chamber; and
(c) a substantially annular and continuous feedstock injection slot connecting the plenum chamber with the bore, extending inwardly from the plenum chamber toward the axis.

21. The plasma spray nozzle system as defined in claim 20 wherein the nozzle body comprises a first and second part separated by a space and wherein the slot is defined by the space.
